(19) United States
(12) Patent Application Publication
(10) Pub. No.: US 2007/0050372 A1
(43) Pub. Date: Mar. 1, 2007

(54) Systems and methods for creating, managing and publishing advertisements

(75) Inventor: Kenneth James Boyle, Marietta, GA (US)

Correspondence Address: SUTHERLAND ASBILL & BRENNAN LLP, 999 PEACHTREE STREET, N.E., ATLANTA, GA, 30309, US

(73) Assignee: Convergent Media Systems

(21) Appl. No.: 11/215,907

(22) Filed: Aug. 31, 2005

(51) Int. Cl. G06F 17/30

(52) U.S. Cl. 707/10

(57) ABSTRACT

A media distribution system and method, such as an advertising system and method, allows a user to quickly create, manage and publish digital media at numerous media sites using web-based tools. The system also includes a web-based media space search and selection tool that enables a user to select the media outlets (e.g., advertising sites) in which media is placed. Media outlets may include local, satellite and cable television, Internet sites, local networks, and other systems capable of presenting digital signage. The web-based tools of the present invention permit the creation and placement of media on non-digital media, such as in newspapers or magazines.

### FIELD OF THE INVENTION

The present invention relates generally to media delivery, and more particularly to media distribution systems and methods that enable users to create and deliver sponsored messages to user-specified, targeted audiences.

### BACKGROUND OF THE INVENTION

Conventional advertising, such as via print media, typically requires the presentation of ads to large-scale audiences in an effort to target a specific sub-audience within that audience. As a result, such advertising can be cost-prohibitive for smaller companies, and particularly those that with to promote their goods or services only at a local level. There may be, in fact, no appropriate media outlet for directed advertising. Companies that can afford such advertising often also forego such advertising due to low returns on advertising investment, which results from the inability to tailor an advertising plan to target a specific class of persons or customer base.

Another impediment to advertising is the quick dissemination of time-sensitive advertising material and at a low cost. For instance, a small company running a two-day sale who wants to create a rich electronic media based advertisement may do without from a conventional advertising method due to the costs associated with generating an ad and the delay between an ad concept and the distribution of the ad.

What is therefore needed are media distribution systems and methods that enable users to easily and quickly create and deliver ads to user-specified, targeted audiences.

### BRIEF SUMMARY OF THE INVENTION

According to one embodiment of the invention, there is disclosed a method for placing media content. The method includes receiving, at a server, a user request to identify available media space, where the user request includes one or more user-identified search criteria, and where the available media space represents media space available for purchase by the user. The method also includes determining, at the server, the available media space that meets the one or more user-identified search criteria, and displaying the available media space to the user for purchase.

According to one aspect of the invention, the method also includes receiving a request, from the user, to purchase at least some of the available media space. The method may also include selling the at least some of the available media space to the user. The method may additionally include providing the user at least one media space selection module operable to (a) permit the user to input the one or more user-identified search criteria, (b) review the available media space meeting the one or more user-identified search criteria, and (c) purchase the at least some of the available media space, where the at least one media space selection module is accessible by the user via the Internet.

According to another aspect of the invention, the method may include receiving a request, from the user, to publish media content on the media space sold to the user. According to yet another aspect of the invention, the method may including providing at least one media creation module, accessible by the user, which is operable to permit the user to create, at least in part, the media content for publishing on the media space sold to the user. The method may further include publishing the media content on the media space sold to the user. The publishing of media content may also be scheduled, and/or may include displaying the media content on at least one display. According to another aspect of the invention, publishing the media content may include publishing the media content in printed material. The media content may include an advertisement and/or real-time or near-real time content.

According to another aspect of the invention, the method includes providing a publishing module operable to permit the user to input the request to publish the media content on the media space sold to the user. The method may also include reviewing the media content requested for publication by the user. The user request to publish the media content may also be approved prior to publishing the media content on the media space sold to the user. Additionally, the method may include instructing the user that the media content must be revised before the media content is published.

According to another embodiment of the invention, there is disclosed a method for the sale of advertising space at one or more advertising sites. The method includes receiving, at a server, a user request to identify available advertising sites, where the user request includes one or more user-identified search criteria. The method further includes determining, at the server, the available advertising sites that meet the one or more user-identified search criteria, and offering for sale, to the user, advertising space in at least some of the available advertising sites.

According to one aspect of the invention, the method includes providing at least one content creation tool for access by the user, where the at least one content creation tool is operative to allow the user to create and store advertisements. According to another aspect of the invention, the method further includes receiving a request, from the user, for the purchase of advertising space in at least some of the available advertising sites, and selling the at least some of the available advertising space to the user. According to yet another aspect of the invention, the method includes providing a publishing module operable to permit a user to publish an advertisement on the advertising space sold to the user.

The method may further include receiving a request, from the user, to publish an advertisement on the advertising space sold to the user, and publishing the advertisement on the advertising space sold to the user. The method may also include scheduling the publishing of the advertisement on the advertising space sold to the user. According to another aspect of the invention, the in at least some of the available advertising sites may include a video network. The advertisement may also include real-time or near-real time content. The method may also include generating a bill corresponding to the sale of advertising space sold to the user. Furthermore, the method may include approving of the user request to publish the advertisement, prior publishing the advertisement on the advertising space sold to the user.

According to yet another embodiment of the invention, there is disclosed a media distribution system. The system includes a server, operable to communicate with a computer corresponding to a user, and a media space selection module, in communication with the server, where the media space selection module is operable to (a) receive one or more user-identified search criteria to identify available media space, where the available media space represents media space available for purchase by the user; (b) determine the available media space that meets the one or more user-identified search criteria, and (c) display, on at least one display corresponding to the computer, the available media space to the user for purchase.

According to one aspect of the invention, the media space selection module is further operable to receive a request, from the user, to purchase at least some of the available media space. The system may also include at least one credit card authorization server, in communication with the server, where the at least one credit card authorization server is operable to process payment relating to the sale of at least some of the available media space to the user. In the system, the at least one media space selection module may be accessible by the user via the Internet.

According to another aspect of the invention, the system may include a media creation module accessible by the user and operable to permit the user to create, at least in part, the media content for publishing on the media space sold to the user. According to yet another aspect of the invention, the system may include a publishing module operable to permit the user to input the request to publish the media content on the media space sold to the user.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows a block diagram of an advertising system, according to an illustrative embodiment of the invention.

FIG. 2 shows a block diagram illustration of the advertising module, according to an exemplary embodiment of the present invention.

FIG. 3 is a block diagram flow chart of an ad space search and selection process, according to an illustrative embodiment of the present invention.

FIG. 4 is an illustrative log-in and search graphical user interface (GUI), according to an embodiment of the present invention.

FIG. 5 shows a search criteria selection in the illustrative log-in and search GUI of FIG. 4, according to an embodiment of the present invention.

FIG. 6 shows an ad space search and selection GUI, according to an embodiment of the present invention.

FIG. 7 shows a search criteria selection in the illustrative ad space search and selection GUI of FIG. 6, according to an embodiment of the present invention.

FIG. 8 shows an additional search criteria in the illustrative ad space search and selection GUI of FIG. 6, according to an embodiment of the present invention.

FIG. 9 shows a network selection in the illustrative ad space search and selection GUI of FIG. 6, according to an embodiment of the present invention.

FIG. 10 shows selection of available ad space inventory in the illustrative ad space search and selection GUI of FIG. 6, according to an embodiment of the present invention.

FIG. 11 shows an ad space purchase GUI, according to an embodiment of the present invention.

FIG. 12 is a block diagram flow chart of an ad creation process, according to an illustrative embodiment of the present invention.

FIG. 13 shows a content manager GUI for use in ad creation or revision, according to an illustrative embodiment of the present invention.

FIG. 14 shows a message creator GUI, including ad background media, for use in ad creation or revision, according to an illustrative embodiment of the present invention.

FIG. 15 shows a message creator GUI after the selection of background media for use as an ad template, according to an illustrative embodiment of the present invention.

FIG. 16 shows a message creator GUI, including image media, for use in ad creation or revision, according to an illustrative embodiment of the present invention.

FIG. 17 shows a message creator GUI, including a text insertion tool, for use in ad creation or revision, according to an illustrative embodiment of the present invention.

FIG. 18 shows a message creator GUI with an ad in a vertical orientation, according to an illustrative embodiment of the present invention.

FIG. 19 shows a save ad GUI, according an illustrative embodiment of the present invention.

FIG. 20 is a block diagram flow chart of an ad approval process, according to an illustrative embodiment of the present invention.

FIG. 21 shows a message publisher GUI for use in ad approval and publishing, according to an illustrative embodiment of the present invention.

FIG. 22 shows the message publisher GUI of FIG. 21 including the addition of a new ad, according to an illustrative embodiment of the present invention.

FIG. 23 shows a home screen GUI for use in managing ads, according to an illustrative embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The present invention is described below with reference to block diagrams and flowchart illustrations of methods, apparatuses (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions and/or hardware. Computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present invention is a media distribution system and method that allows a user to create, manage and publish digital media at numerous sites using web-based tools. The system also includes a web-based media space search and selection tool that enables a user to search for available media outlets to determine the availability of media space in those outlets. The user may subsequently select to purchase available media space and to display media at the purchased media space. According to one aspect of the present invention, media may be placed in media outlets that include local, satellite and cable television, Internet sites, local networks, and other systems capable of presenting digital images. According to another aspect of the invention, the web-based tools of the present invention permit the placement of media in non-electronic media outlets such as in printed ads in newspapers, magazines and billboards.

According to an embodiment of the invention, the media distribution system may be an advertising system that allows a user to create, manage and publish digital ads at numerous advertising sites. It will be appreciated that the present invention is described herein with respect to the display of advertisements at advertising sites. More specifically, the methods and systems described herein, along with the illustrative GUIs, are each discussed with respect to the creation and placement of ads at available advertising sites identified by a user via a web-based search tool. However, it should be appreciated that the present invention is not limited to placement of ads at advertising sites. Rather, the embodiments described herein are illustrative and non-limiting examples, such that the systems and methods of the present invention may facilitate the placement of media at any media outlet. Additionally, terms such as ads or advertisements are only representative of one form of media or media content, and advertising sites are only representative of one form of media outlet.

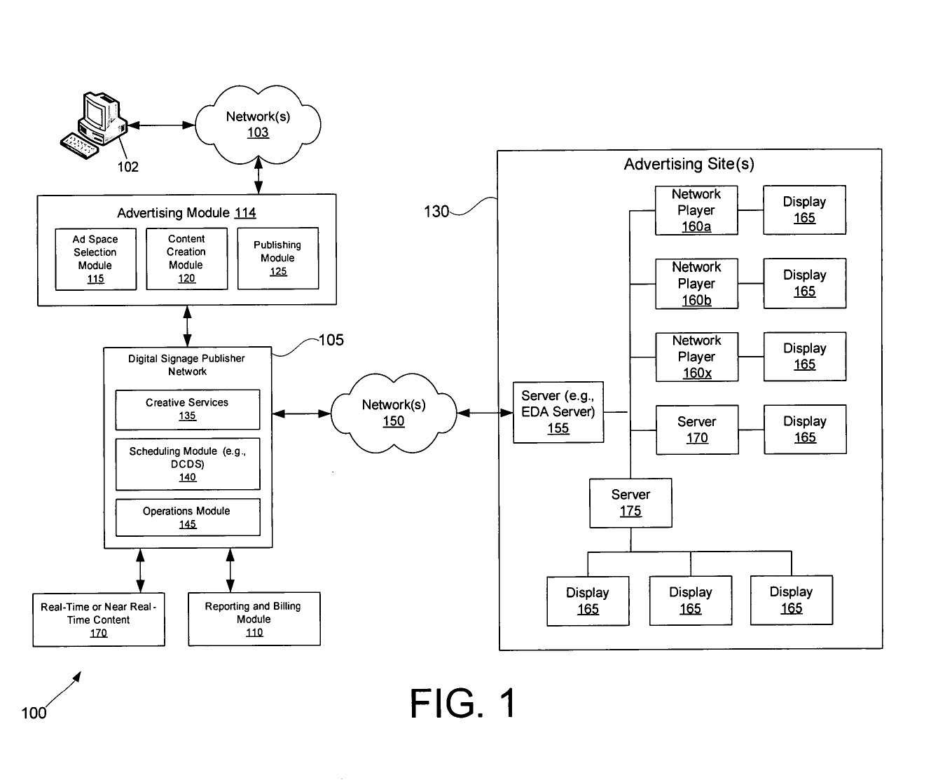

FIG. 1 shows a block diagram of a media distribution system 100, according to an illustrative embodiment of the invention. The system 100 includes at least one user computer 102 in communication with an advertising module 114 via one or more network(s) 103. The advertising module 114 may include a server operable to run one or more software applications, and includes an ad space selection module 115, a content creation module 120, and a publishing module 125. Generally, the ad space selection module 115, content creation module 120, and publishing module 125 provide the user with web-based interfaces to enable a user, via the computer 102, to search and select ad space and to create, manage and publish digital ads. As described in greater detail below, the ad space selection module 115, content creation module 120, and publishing module 125 also implement many of the functions of the present invention with the aid of a digital signage publisher network 105.

According to one aspect of the invention, ad space selection module 115, content creation module 120, and publishing module 125 reside in computer software at the advertising module 114 and are accessible by a user via the computer 102 over the Internet. In such an embodiment, a user may communicate with the advertising module 114 using an Internet browser (on the computer 102) that permits the user to view HTML pages, which are preferably displayed in graphical format. Well-known web browsers such as Netscape navigator and Microsoft Explorer automatically format data that is programmed in the HTML language according to well-known protocols. According to an aspect of the invention, information is transported back and forth between the computer 102 and the advertising module 114 according to a well-known protocol, such as the HyperText Transport Protocol, although other protocols, such as FTP, are also available.

Messages are sent from the computer 102 to one or more servers at the advertising module 114, which can include a web server and/or HTTP server. As is well known in the art, a web server may have installed on it files that include HTML documents or may dynamically generate HTML documents that can be displayed on a screen of the user's computer 102. Thus, without the need for any hardware or software, other than a standard personal computer and a common web browser, a user can access the ad space selection module 115, content creation module 120, and publishing module 125 residing in computer software at the advertising module 114.

The user's computer 102 may include various standard components, including a central processing unit and associated read-only memory (ROM), both of which are connection along data and address bus lines to a random access memory. Also connected to the RAM, the CPU and the ROM via the bus are an input/output interface (I/O) and I/O device. The CPU is operatively connected to the I/O interface to control any corresponding I/O devices. Typical I/O devices may include a video display, a keyboard, a scanner, and a mouse or joystick or other input or output devices. The computer 102 may also include a storage device, which may be any conventional device for storing data, such an external hard disk. The computer 102 further includes a system for connection to the communications network 18, which may be a modem. The computer 102 is thus equipped similarly to any typical personal computer that can access the Internet. Additionally, installed on the computer 102 is an operating system that controls various applications of the computer 102. Applications include applications for data management, storage and retrieval, a web browser application that is capable of formatting HTML documents, a communications application capable of controlling communications between the computer 102 and the network(s) 103.

As shown in FIG. 1, the advertising module 114 with which the user communicates is also in communication with a digital signage publisher network 105, which can include creative services 135, a scheduling module 140, and an operations module 145. Generally, the digital signage publisher network 105 is operable to publish advertisements created using the advertising module 114, where the scheduling module 140 is operable to transmit user-generated ads, created using the advertising module 114, to one or more advertising sites 130 via one or more networks 150. The scheduling module 140 is operable control the display of user-created ads on the advertising sites 130 such that the ads are displayed based on the ad space purchased by the user via the ad space selection module 115. The scheduling module 140 is further operable to communicate real-time or near real-time scheduling information to the advertising module 114, which includes ad space availability information. This permits the advertising module 114, and more specifically, the ad space selection module 115, to display up-to-date information detailing what ad space is available in the system 100.

According to an aspect of the invention, the scheduling module 140 may be a Sony DCDS™ (dynamic content delivery system (DCDS). Generally, a DCDS, as is known in the art, is a system that receives requests for the delivery of content, e.g., over a first network, and delivers the requested content over the same or a different network. The content may be audio recordings, video recordings, or other content suitable for delivery over a network (e.g., stock tickers, news headlines, sports scores, etc.). More particularly, the scheduling module 140 according to the present invention may represent a DCDS operable to receive multiple requests for scheduled content delivery, and to manage the requests, using scheduling algorithms, so that each request for scheduled content delivery is automatically fulfilled. The scheduling module 140 can therefore manage and distribute content, such as advertisements (including video, audio, graphics, text, and the like), to the remote advertising sites 130. According to an aspect of the invention, the scheduling module 140 is also operable to transmit user-generated ads and other content while permitting gaps for the insertion of live content. Because the dynamic delivery of content via a DCDS system is well known, the scheduling module 140 is not described in further detail herein. Nevertheless, it should be appreciated that the scheduling module 140 may include any hardware and/or software for implementing a DCDS, including schedulers, managers, databases, and architecture for supporting fully automated scheduling and tracking of content assets, as well as the transfer of such content through other software systems satellite or terrestrial networks to IP-addressable digital network players, which store, exchange and play the content in each of the specific destinations.

Referring again to FIG. 1, the digital signage publisher network 105 may also include the operations module 145, which can include software and/or hardware for monitoring the status of user-generated ads playing (or having already completed playing) at one or more advertising sites 130. The operations module 145 may also include reporting and billing applications to bill users for ads played at advertising sites. According to an aspect of the invention, the operations module 145 may communicate with a reporting and billing module 110, which may be used to automatically generate bills for payment by those using the system 100 to create and publish ads. It will be appreciated that because each ad space and/or user may correspond to different charges and/or rates, the operations module 145 should be operable to track billing for all advertisements played at any ad site. This may also be desirable for billing purposes should one or more ads be unplayable by the system 100 due, for instance, to an advertising site 130 being off-line or otherwise unavailable.

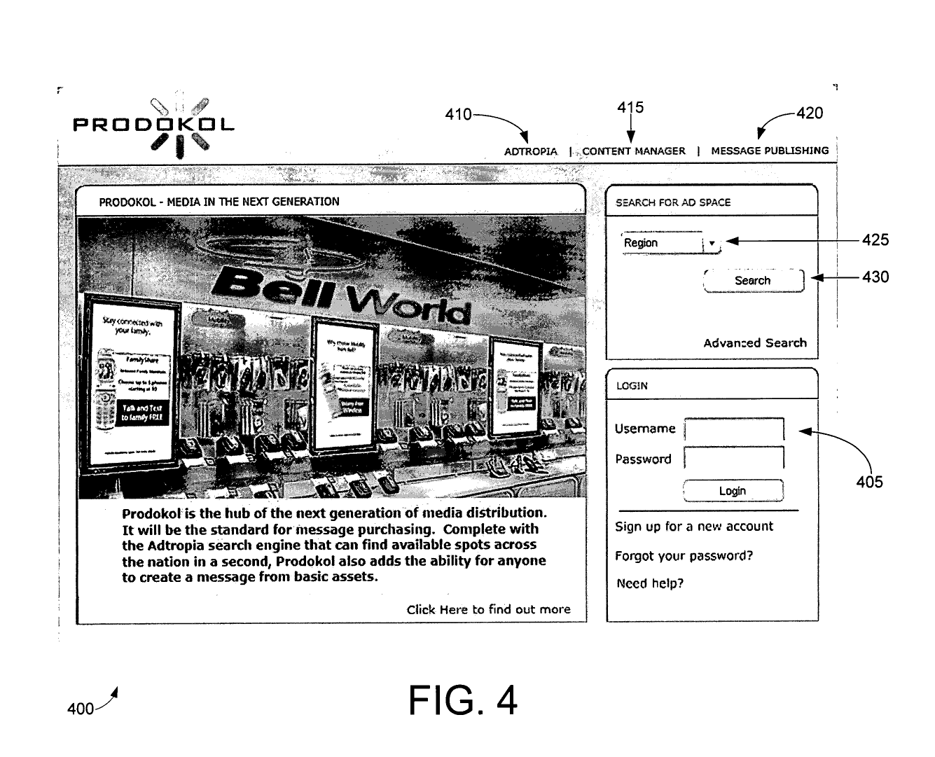

The digital signage publisher network 105 can also include creative services 135, which may include professional editing personnel and/or software, and media (e.g., templates, backgrounds, pictures, and the like) that is used to aid in the publication of ads made by users using the advertising module 114. As will be explained in detail below with reference to FIG. 4, creative services 135 may approve user-created ads prior to the scheduling module 140 forwarding the ads to advertising sites 130. This approval may be required not only for the content of the ads, but also for format, including length, size, file type, and the like. Additionally, creative services 135 may wish to preview user created ads to ensure that they appear professionally formatted or rendered. It will be appreciated, however, that creative services 135 is optional, and that the present invention may be implemented to automatically publish any ads created by users as described herein.

The system 100 shown in FIG. 1 also includes real-time or near real-time content 170. The real-time or near real-time content 170 may be transmitted to advertising sites 130 by the scheduling module 140 along with user-created ads. According to an aspect of the invention, the scheduling module 140 can transmit real-time or near real-time content 170 for display during gaps in the playing of ads. According to another aspect of the invention, the real-time or near real-time content 170 may be inserted into ads, such that the ads include the real-time or near real-time content 170 along with stored content. As an illustrative example, a user wish to advertise a product or service at a sporting venue, where the advertisement includes real-time streaming sports scores in a ticker-type display. Additionally, to ensure seamless integration of the real-time or near-real time content 170 with stored content, creative services 135 may be used to generate dynamic graphics that integrate the two digital media components.

As shown in FIG, 1, the digital signage publisher network 105 may be in communication with one or more media outlets, or advertising sites 130, via one or more networks 150, which may include satellite networks, cable networks, the Internet, local-area networks (LANs), or any other network capable of transmitting video and/or audio content to near or remote locations. According to one embodiment, the digital signage publisher network 105 may be located at a single facility and may transmit user-created ads to advertising sites 130 via satellite.

Each advertising site 130 may include a server 155, such as an EDA server, for receiving content provided by the digital signage publisher network. The server 155 distributes content, including user-generated ads to displays 165 via one or more network players 160a-160x and/or servers 170, 175, as is known in the art. According to an illustrative aspect of the invention, the displays 165 may include Plasma, LCD, DLP, or CRT displays, or the like, located at an advertising site. Because each advertising site 130 only requires a single server, and network players and displays, each advertising site 130 may incur very little expenditure in setting up a digital advertising system. Additionally, because the scheduling of content, including user-generated ads, is managed by the scheduling module 140, very little setup or maintenance of the advertising site 130 is required.

The media distribution system 100 illustrated in FIG. 1 is an illustrative embodiment of a system of the present invention in which ad space is identified and selected for purchase, and in which ads may be created and published at one or more advertising sites. More generally, however, it will be appreciated by those of ordinary skill in the art that the system 100 described with respect to FIG. 1 may be used to effect the identification of media space for purchase by a user, where media content is created and published at one or more media outlets. Thus, for example, the advertising module 114 may represent a media module, the ad space selection module 115 may represent a media space selection module, and the content creation module may represent a media creation module. As s further example, the publication module may be operative to publish media other than advertisements. Regardless whether applied to media generally or to advertising (a type of media), each of the components perform in the same manner as described above and in further detail below.

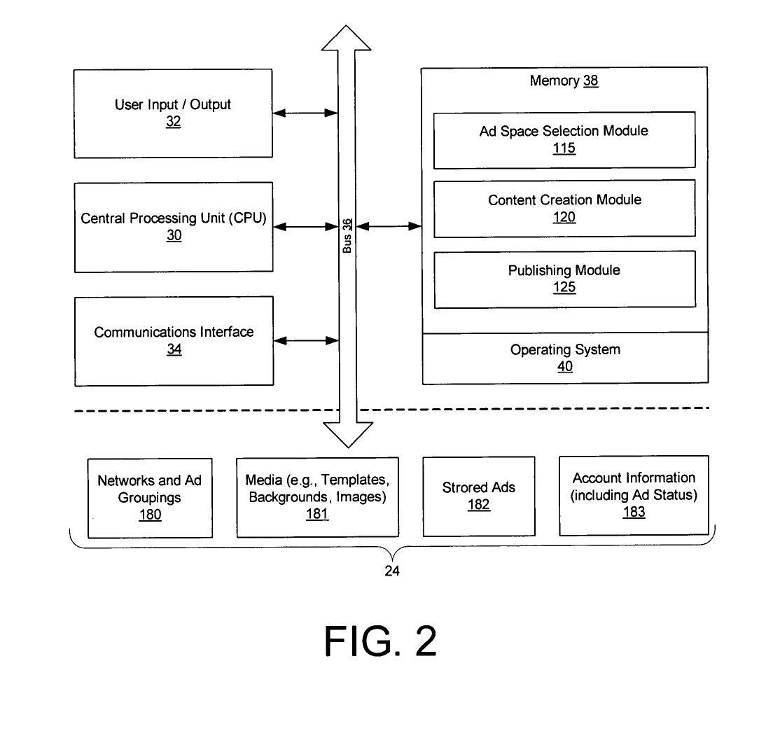

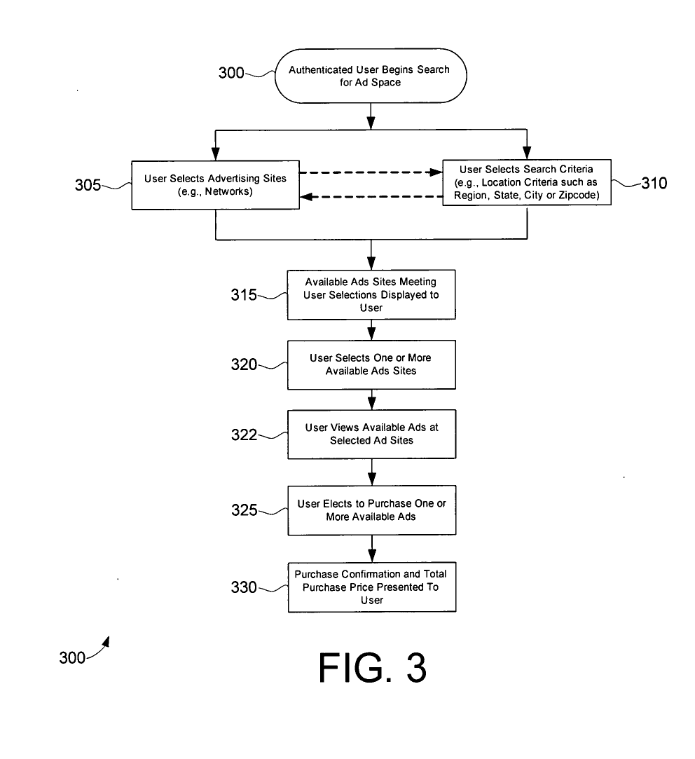

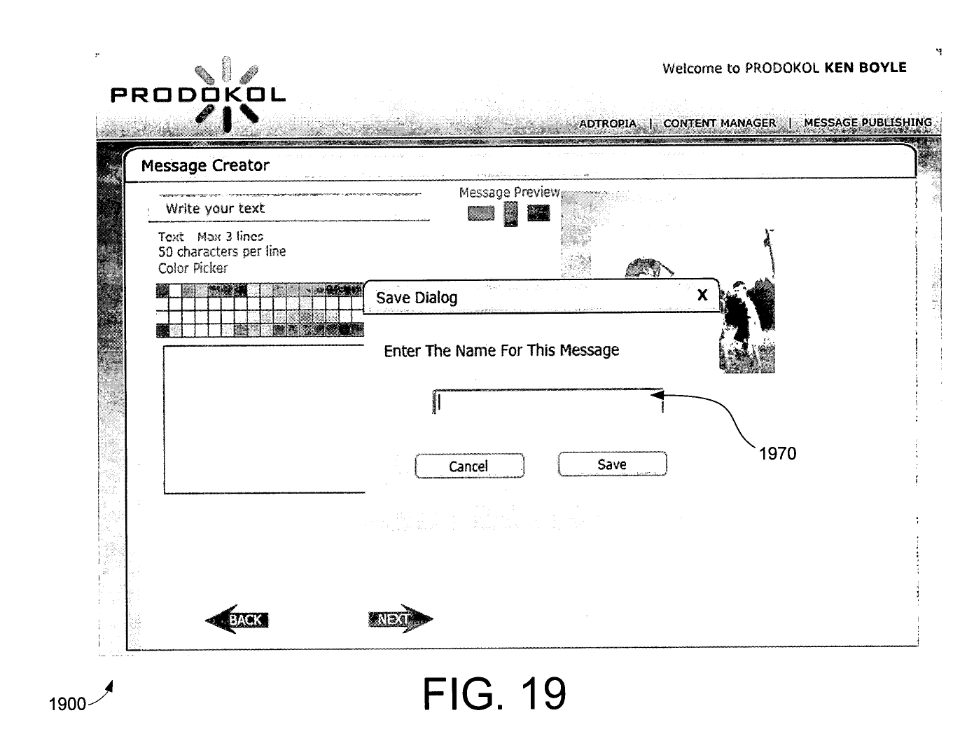

Next, FIG. 2 shows a block diagram illustration of the advertising module 114, according to an exemplary embodiment of the present invention. As shown in FIG. 2, the advertising module 114 comprises a CPU 30, a User I/O 32, a communications interface 34 (for interfacing and communicating with other elements of a network), a Bus 36, a memory 38, an operating system 40, and a plurality of databases 24. A number of program modules may be stored by the memory 38, including the ad space selection module 115, the content creation module 120, and the publishing module 125. Each of the program modules stored in memory 38 operate with the assistance of one or more CPUs and operating systems, such as the CPU 30 and the operating system 40. The features and functions of each module 115, 120, and 125 are discussed in detail with respect to FIGS. 3-22.

Briefly, the ad space selection module 115 identifies the ad space available for purchase at the one or more advertising sites 130. The ad space selection module 115 provides search capabilities to permit a user to identify one or more advertising sites based on geographic location. Using the ad space selection module 115 the user may also select one or more time sensitive ad groupings. For instance, the user may select to advertise at a particular ad site every other month by purchasing monthly ad groupings for only the months the user would like to advertise. According to an aspect of the invention, the identity of advertising sites may be stored local to the advertising module 114, although it should be appreciated that ad space availability for such sites, or the identification of advertising sites, may be provided by the scheduling module 140.

The content creation module 120 permits a user to create new ads or to revise previously created ads. Ads may be created using stored media, which may include ad templates, backgrounds, images, video clips, audio clips, or the like. The content creation module 120 also permits a user to upload media for use in generating an ad, and permits a user to upload an entire ad. According to one aspect of the invention, the content creation module 120 can also include a list of all ads associated with a user, which may be stored ads that are associated with a user account stored by the advertising module 114.

The publishing module 125 permits the review and approval of ads prior to their publishing, which may include the display of the ads at the advertising sites selected by the user via the ad space selection module. According to an aspect of the invention, the user may view the approval status of each ad. It will also be appreciated that four illustrative databases are shown in FIG. 2, including a networks and ad groupings database 180, media database 181, stored ads database 182, and an account information database 183. However, it will be appreciated by those of skill in the art that additional databases may exist for implementing the functions of the system 100 as described herein, and that one or more of the databases may be optional where the information (e.g., available networks and ad groupings) are provided by another component of the system 100.

The memory 38 in which the modules 115, 120, and 125 reside may comprise random access memory, read-only memory, a hard disk drive, a floppy disk drive, a CD or DVD Rom drive, or optical disk drive, for storing information on various computer-readable media, such as a hard disk, a removable magnetic disk, a CD or DVD ROM disk, or the like. Likewise, the databases 24 may also comprise such computer-readable media. As will be appreciated by one of ordinary skill in the art, each of the modules 115, 120, and 125 are connected to the bus 36 by an appropriate interface. The modules and databases and their associated computer-readable media provide nonvolatile storage for the advertising module 114. However, it is important to note that the computer-readable media described above could be replaced by any other type of computer-readable media known in the art. It will further be appreciated by one of ordinary skill in the art that one or more of the advertising module 114 components may be located geographically remotely from other advertising module 114 components. Furthermore, one or more of the components may be combined, and additional components performing functions described herein may be included in the advertising module 114.

FIG. 3 is a block diagram flow chart of an ad space search and selection process, according to an illustrative embodiment of the present invention. According to one aspect of the invention, the ad space search and selection process may be facilitated by the ad space selection module 115. As shown in FIG. 3, after a user is authenticated via, e.g., the entry of a username and password, a search for ad space may begin (block 300). Although illustrated in FIG. 3 as requiring authentication before permitting a search, the ad space selection module 115 may also permit the search for available ad space without requiring authentication. However, a user account may be required before any ad space is purchased. The user proceeds with the search for ad space by selecting one or more search criteria (block 310). According to one aspect of the invention, the search criteria may be geographic location criteria. For instance, a user may select a geographic criteria such as geographic region, state, city, or zip code. Other search criteria may be provided to the user, e.g., based on type of advertising site (retail outlet, college cable network, concert venues, etc.) number of displays on a network, or other criteria.

The ad space selection module 115 will identify the ad sites 130 that meet the user's search criteria (block 315). This identification may be based on a comparison of the search criteria to ad site information. For instance, each ad site may include ad site information that identifies the geographic details (e.g., region, state, zip code, city) of the ad site and classifies the ad site according to other search criteria that may be used by users. For instance, because a user may search ad sites based on site type, each ad accessible via the system 100 will include ad site information that includes a site type, which may be used by the ad space selection module 115 to determine if an ad site matches user-selected search criteria. Ad site information may be associated with each ad site and stored, for instance, as metadata. This information may be stored within the networks and ad groupings database 180, or may be stored within and accessed by the advertising module from the scheduling module 140.

After the ad space selection module 115 identifies the ad sites 130 that meet the user's search criteria (block 315), the user may select one or more ad sites (block 320). According to another aspect of the present invention, the user may also select an advertising site based on a list of ad sites provided to the user (block 305). Where the user is authenticated, the user may be presented with sites the user is currently or has recently used for advertising. An authenticated or non-authenticated user may also be presented with a default list of sites, based, e.g., on the location of the user, the popularity of the ad sites, or the availability of ads segments.

According to one aspect of the invention, after a user selects one or more ad sites (block 320), the user is presented with the ad space available at each of the selected sites (block 322). To determine whether ad space is available at any of the sites, the ad space selection module 115 relies on ad space information provided to the ad space selection module 115, which ensures that the information provided to the user is current. Ad space information may be requested by the ad space selection module 115 each time a user search is run, or may be continually updated by the scheduling module, for instance, once every hour. Thus, although a user may select an ad site, the ad site may have no ad space available, which could occur if all the ad space for that ad site is already taken.

According to one aspect of the invention, available ad space is identified to the user based on both location and time, and a user may purchase ad space for a specific block of ad time, such as 1 month at a given location. It should also be appreciated that ad space location may also be more specific than ad site. For instance, an ad site may be identified as a retail store, which may have multiple groups of displays (or ad space locations) at various areas within the store. The store may have no available ad space for the month of January, but may have ad space available for one location in the store in February. Therefore, the user may be presented with an interface that shows, with specificity, the location of available ad space and the time the ad space is available. According to an embodiment of the invention, a user may view available ad space for the next 90 days.

Referring once again to FIG. 3, the user may elect to purchase available ad spaces at one or more ad sites 130 (block 325), and thereafter may select to make the ad space purchase after viewing a purchase confirmation, which may include the total price for the user-selected ad space. Although not illustrated in FIGS. 1 or 3, the purchase of media space, such as ad space, may be effected by credit-card payments using conventional on-line credit-card transactions. Therefore, the present invention may include one or more GUIs, screens and/or system components to permit a user to effect the purchase of ad space using a credit card, and may communicate with one or more third party components or systems, such as credit card authorization servers or the like. Other methods of payment known to those of skill in the art may also be used. Upon purchase of ad space, the ad space selection module 115 will transmit a reservation message to the scheduling module 140 to reserve the user-purchased ad space so that the scheduling module can prevent double booking of the user-purchased ad space. Next, FIGS. 4-11 show illustrative GUIs to effect the search, selection and purchase of ad space.

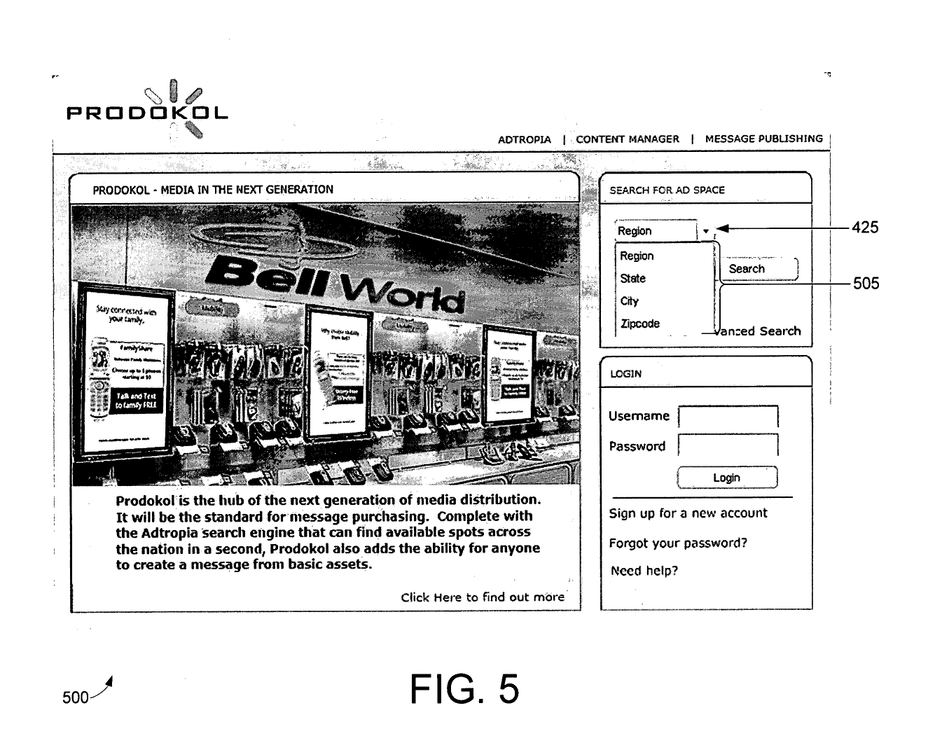

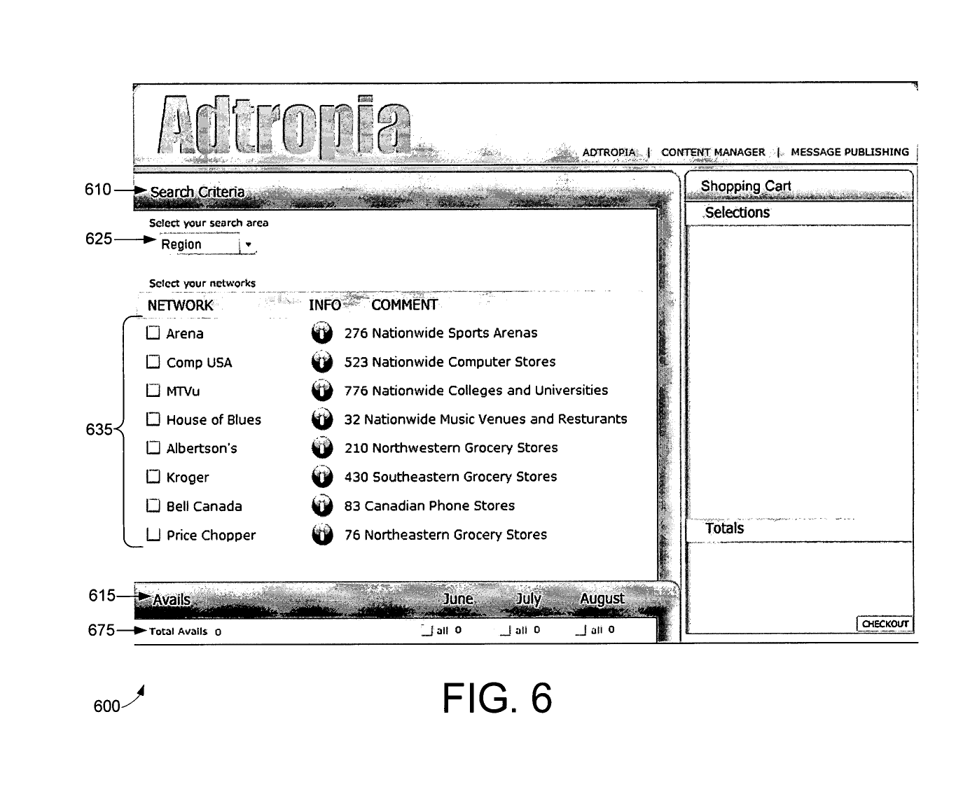

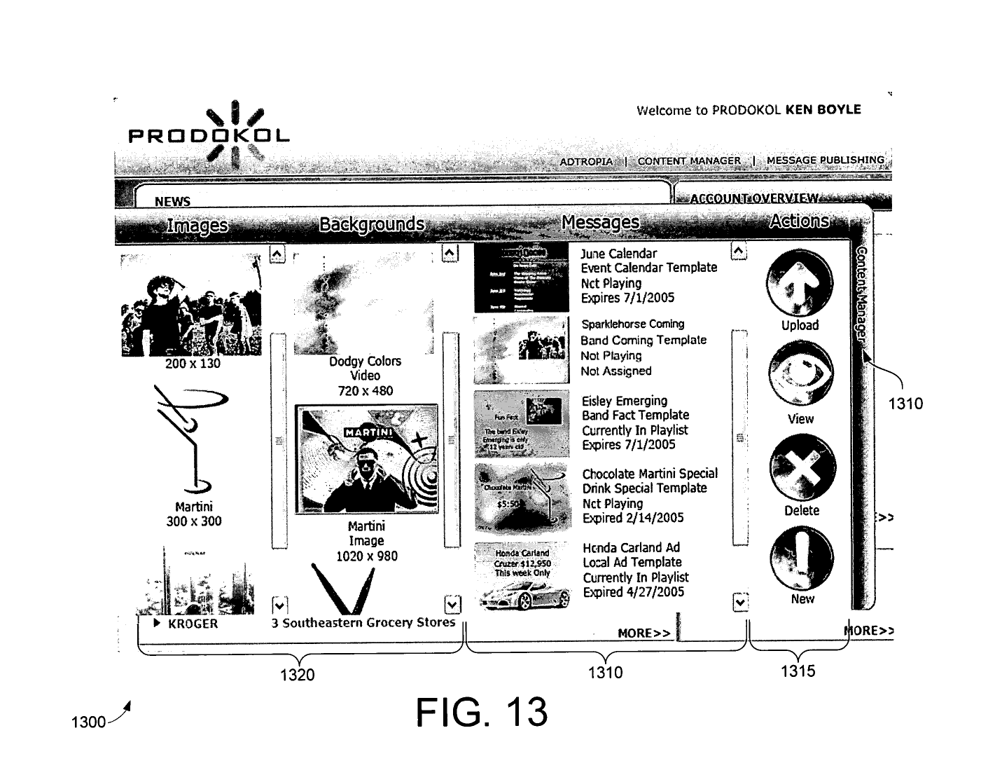

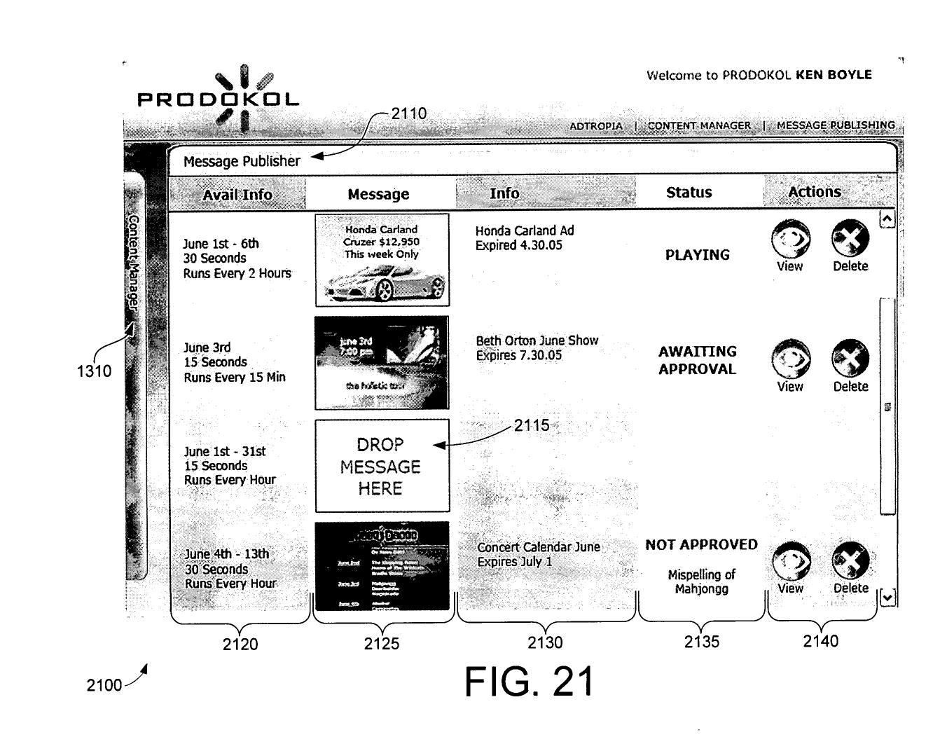

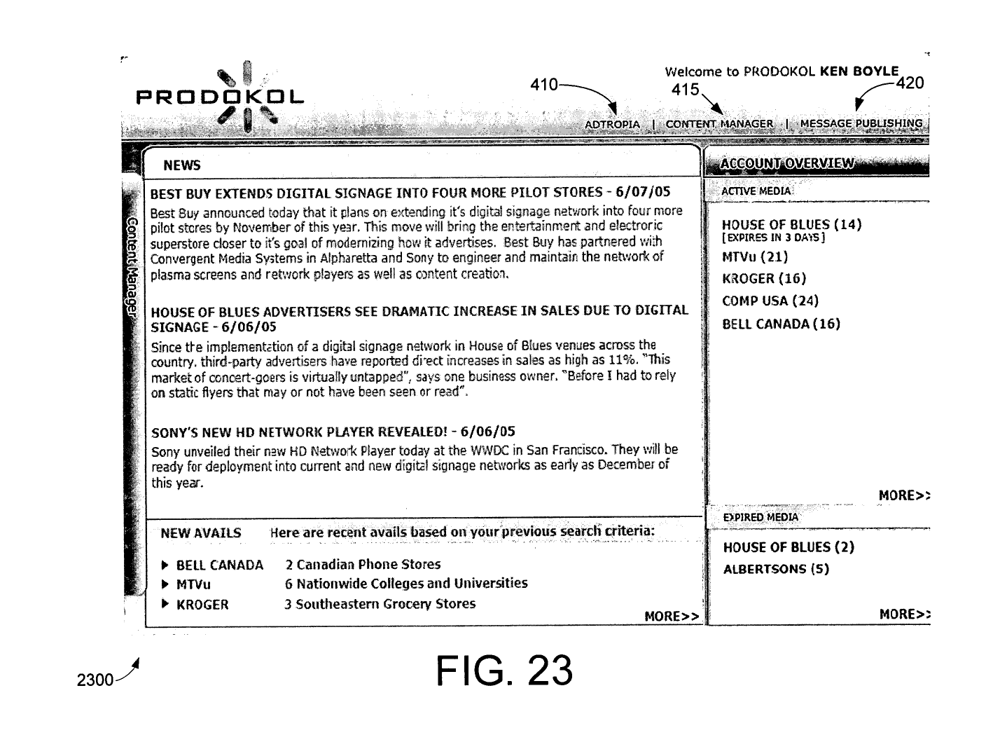

FIG. 4 shows an illustrative log-in and search graphical user interface (GUI) 400, according to an embodiment of the present invention. The GUI 400 includes links 410, 415, 420, respectively, to an ad space search and selection GUI 600 as shown in FIG. 6, a content manager GUI 1300 as shown FIG. 13, and a message publisher GUI 2100 as shown in FIG. 21. The GUI 400 also includes a login tool 405, and a search selection tool that includes a search criteria pull down menu 425 and a search button 430. A user may login via the username and password, after which the user may be taken to a home screen GUI, discussed below with respect to FIG. 23, for managing the user's account. If the user chooses the search criteria pull down menu 425, the user will be presented with the pull down menu choices, as illustrated in the GUI 500 of FIG. 5.

As shown in FIG. 5, the search criteria pull down menu 425 may permit a user to select among geographical criteria, such as geographic region, state, city, or zip code. As described above with respect to FIG. 3, other search criteria may alternatively or also be provided to the user. Continuing with the illustrative example in which a user selects among geographical criteria using the search criteria pull down menu 425, after the user selects the criteria the user is provided with the ad space search and selection GUI 600 of FIG. 6, according to an embodiment of the present invention.

Specifically, the ad space search and selection GUI 600 includes a search criteria window and an avails window that are made active, respectively, by user selection of the search criteria toolbar 610 and the avails toolbar 615. The search criteria window is active in the GUI 600 shown in FIG. 6, while the avails window is minimized. Generally, the search criteria window includes one or more search criteria pull down menus 625 and a list of ad sites 635 meeting the search criteria. The avails window, on the other hand, shows the total available ad spaces 675 for each of the user-selected ad sites (which are zero in the illustrative GUI 600 shown in FIG. 6).

Before search criteria are entered by a user, the list of ad sites 635 may include a default list of sites, based, e.g., on the location of the user, the popularity of the ad sites, or the availability of ads space. The list 635 of ad sites are illustrated in FIG. 6 as networks, as each exemplary ad site in the GUI 600 of FIG. 6 includes a network of digital signs. Each ad site in the list 635 may be individually selected by the user, e.g., by clicking on the square box to the left of each ad site name. The list 635 of ad sites also includes comments specific to each ad site, such as the number of locations of the ad sites, the number of retail stores for an ad site, or the like.

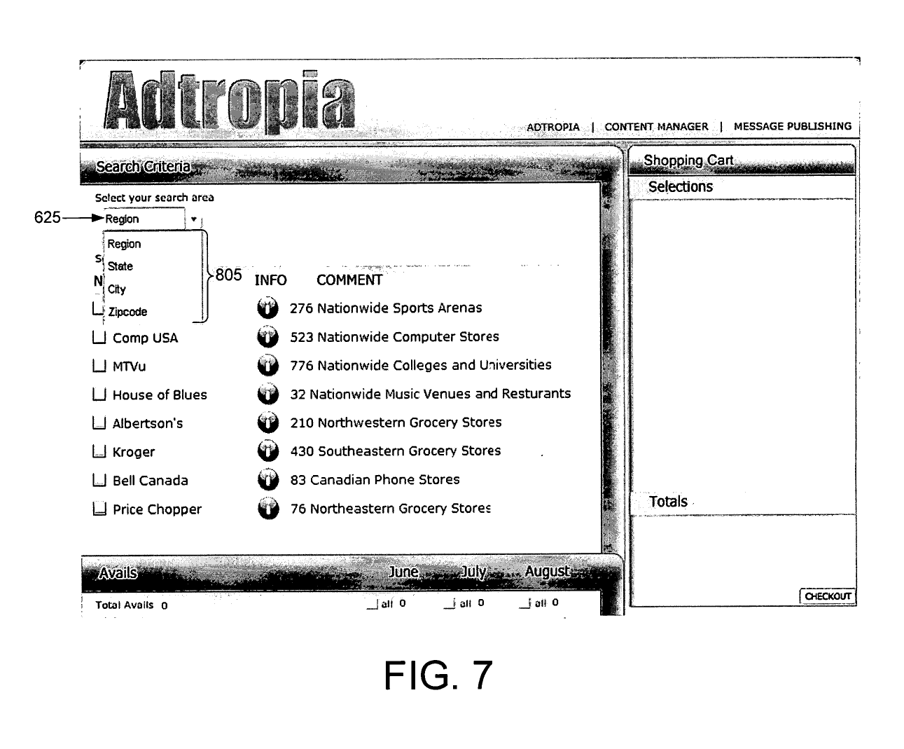

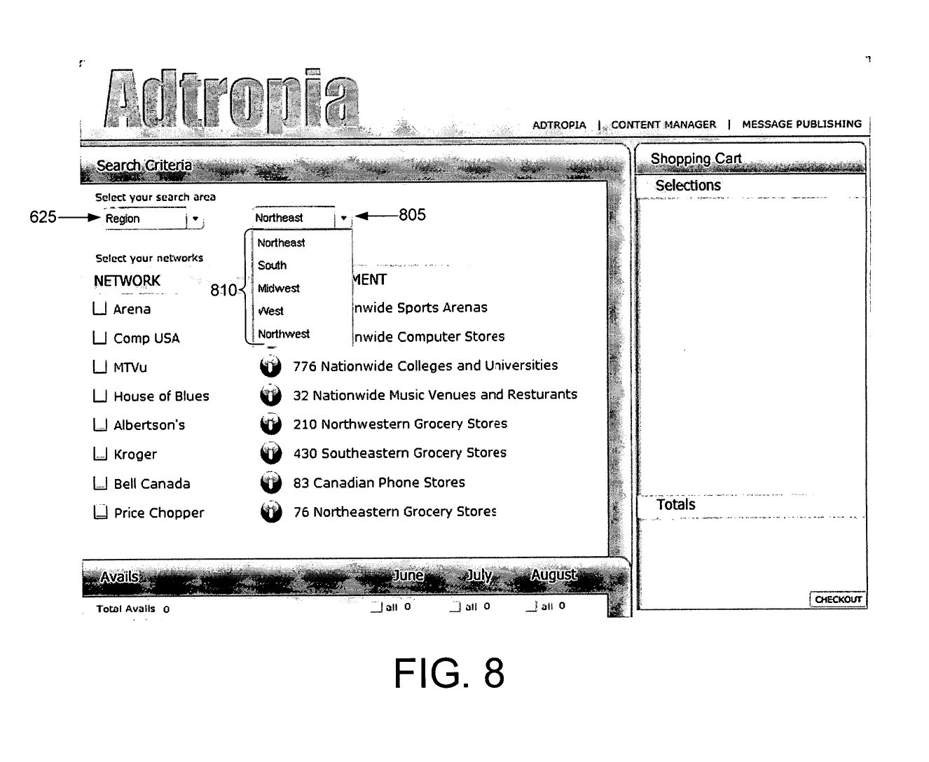

According to one aspect of the invention, the search criteria window can default to the last selection made by the user via the search criteria pull down menu 625. As shown in FIG. 7, a user may select the search criteria pull down menu 625, for instance, to select among geographical criteria, such as geographic region, state, city, or zip code. As shown in FIG. 8, the user can be presented with additional search criteria pull down menus 805 that provide more specific, lower-level search criteria 810. For instance, where the user selects to search by geographic region using the search criteria pull down menu 625, the search criteria may be further narrowed to the northeast, south, Midwest, west, or northwest using the additional pull down menu 805. Although only two pull down menus 625, 805 are illustrated in FIG. 8, it should be appreciated that additional pull down menus may be implemented to narrow the number of ad sites presented to the user. For instance, instead of a search area, the search pull down menus may also filter ad sites based on site type.

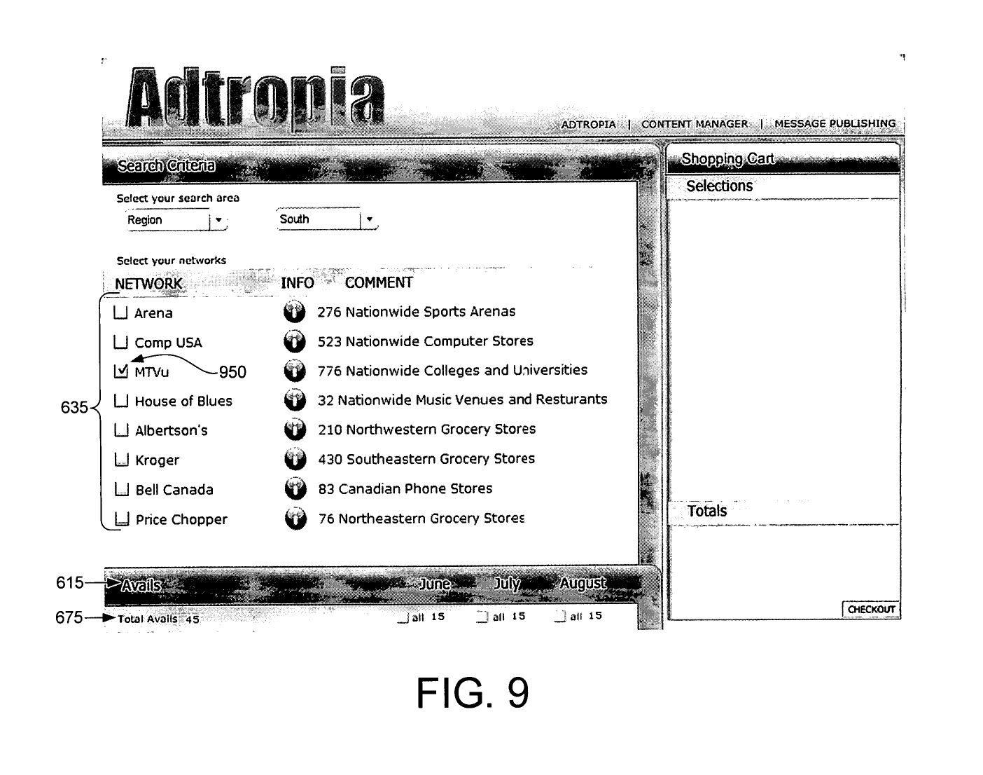

Next, FIG. 9 shows the selection of a network 950 from the list 635 of ad sites. Upon the selection of at least one ad site by clicking on its selection box, the total available ad spaces 675 for each the user-selected ad sites is updated. As illustrated below the avails toolbar 615 shown in FIG. 9, after the network 950 is selected, the total ad spaces 675 corresponding to that network for June, July and August is shown, where those months show the ad space available to the selected network 950 for approximately the next 90 days. It will be appreciated that the available ad spaces may be shown for a period of time greater than or less than 90 days, including a user-selected amount of time using one or more pull down lists or selection tools (not illustrated). To determine whether ad space is available at any of the sites, the ad space selection module 115 relies on ad space information provided to the ad space selection module 115 , as described above with respect to FIG. 3.

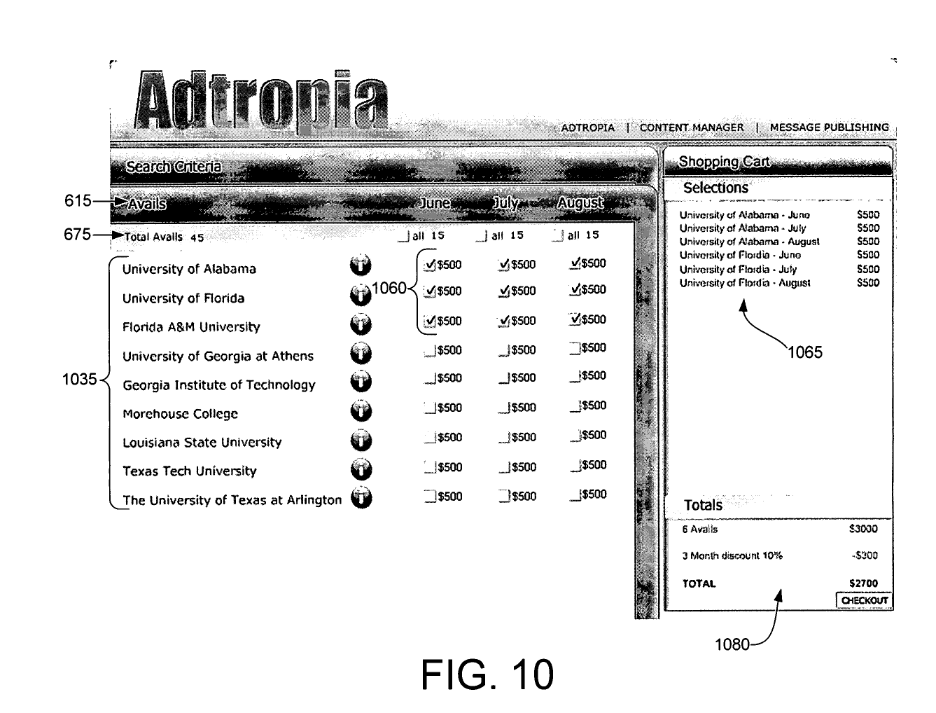

FIG. 10 shows selection of available ad space inventory presented by selection of the avail toolbar 615, which presents the avails window in the illustrative ad space search and selection GUI of FIG. 6, according to an embodiment of the present invention. The avail window shows a detailed ad space list 1035 showing the total available ad spaces 675 corresponding to those ad sites selected by the user via the search criteria window and list 635 of ad sites. The list identifies the ad spaces for purchase based on the location of available ad space and the time the ad space is available. In the illustrative embodiment of FIG. 10, the user views the available ad space for months June through August which may be approximately the next 90 days. The cost of purchasing ad space for a block of time is also illustrated, and the user may select to purchase ad space by selection of one or more location and time specific purchase boxes. For instance, in the embodiment shown in FIG. 10 the user has selected each of the purchase ad space for June, July and August on the networks at the University of Alabama, University of Florida, and Florida A&M University 1060.

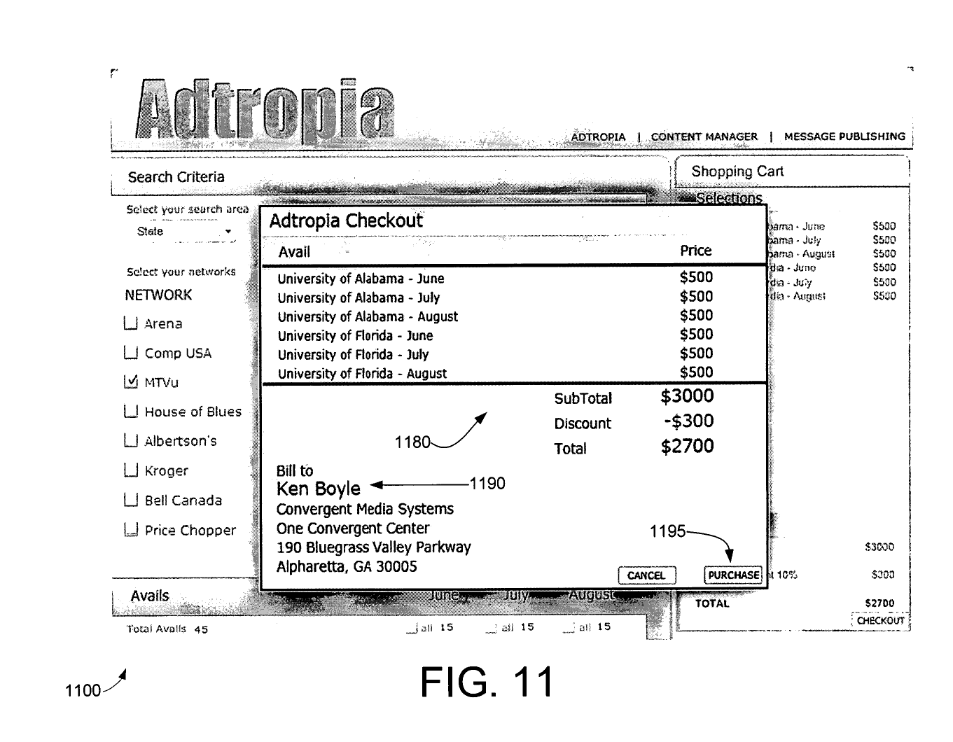

Upon selection of one or more location and time specific purchase boxes, a shopping cart list 1065 is automatically updates with the user's sections. The shopping cart 1065 may also include the cost of each ad space selected by the user. According to another aspect of the invention, a total window 1080 may also be displayed showing the total cost of the user-selected ad space. After the user has completed selecting ad space, the user may select checkout to proceed to the ad space purchase GUI 1100 shown in FIG. 11, according to an embodiment of the present invention.

The ad space purchase GUI 1100 is presented to known users, such as those users that have accounts and who have logged into the system 100. Therefore, before the ad space purchase GUI 1100 is shown, a user may be required to complete registration information (not shown). Among other information collected during registration is name and billing information 1190 that may be used by the system 100 to automatically bill a user for purchased ad space. As shown in FIG. 11, a summary list 1180 of the proposed purchase is shown, including the price of each ad space selected, a total price for all selected ad spaces, and any discounts that may be provided to a user. The user may proceed with purchasing the ad space by selecting a purchase button 1195. After selection of the purchase button, the user will be presented with the content manager GUI 1300 for use in creating ad to be displayed on the user purchased ad space, as described in detail below.

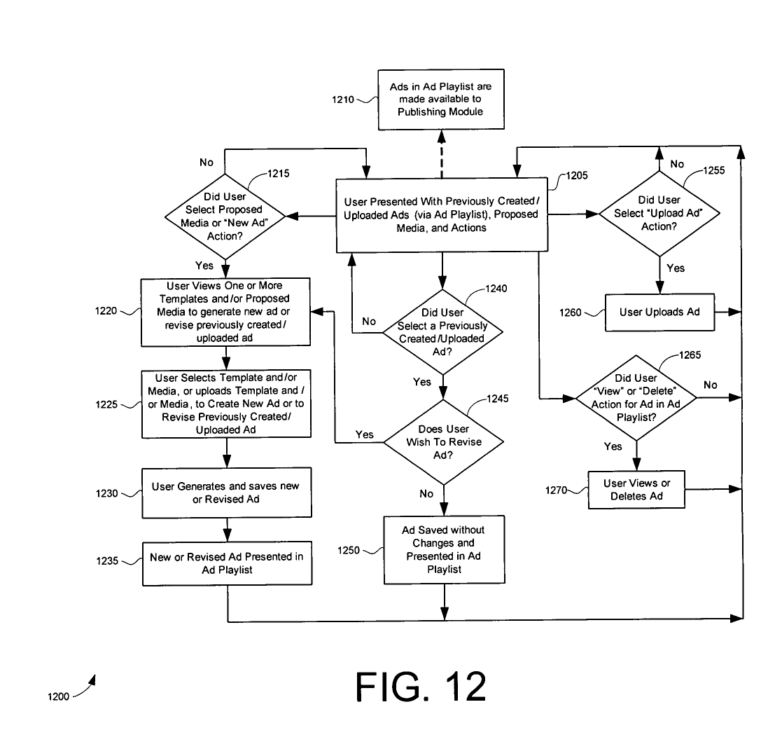

Next, FIG. 12 shows a block diagram flow chart of an ad creation process 1200, according to an illustrative embodiment of the present invention. According to one aspect of the invention, the ad creation process may be facilitated by the content creation module 120.

At the beginning of the ad creation process 1200 the user may be presented with a list of previously created ads (via an ad playlist), proposed media (including images and backgrounds) for creating new ads, and one or more actions icons or buttons, including “upload”, “view”, “delete” and/or “new” (block 1205). When the user selects the “new” action icon or button, or selects from among the proposed media, the user may be presented with one or more templates and proposed media to generate a new ad (block 1220). Using the templates and/or media, the user may create a new ad (block 1225). According to one aspect of the invention, the templates and/or media may be uploaded to the advertising module 114 by the creative services 135. According to another aspect of the invention, the user may create a new ad by uploading an ad template and/or media (block 1225). Upon completion of creating a new ad, the user may save the ad (block 1230), after which the ad is stored in the advertising module 114 and presented to the user in an ad playlist (block 1235). As described above, the ad playlist may include a list of all previously created ads, and may include graphical depictions of each. Ads in the ad playlist may be viewed or deleted (blocks 1265, 1270).

As shown in FIG. 12, instead of choosing to create a new ad, a user may upload an ad by selecting an “upload” icon or button. When selected the user is prompted with an upload screen, as known in the art, that permits the user to upload one or more files to the advertising module 114 that represent previously created digital ads stored on the user's computer 102 or at a remote site accessible to the user via the user computer 102. An uploaded ad may include audio, video, and/or graphics. After the user uploads an ad it is added to the ad playlist, where it can be viewed or deleted (blocks 1265, 1270).

A user may also select an ad that was previously created or uploaded (block 1240). This may occur, for instance, where the user wishes to revise the ad. If the user wishes to revise the ad, the user may be provided with one or more templates and proposed media to revise the ad (blocks 1220, 1225). According to another aspect of the invention, the user may revise an ad by uploading an ad template and/or media (block 1225). Upon completing revision of the ad, the user may save the ad (block 1230), after which the revised ad is stored in the advertising module 114 and presented to the user in an ad playlist (block 1235), where it can be viewed or deleted (blocks 1265, 1270).

As described above with reference to FIG. 11, a user may begin the ad creation process 1200 immediately upon selecting ad space for purchase. Therefore, using the present invention a user may quickly search for and purchase ad space, and create advertisements to be offered on the purchased ad space. Using the tools provided by the advertising module 114 this process may be completed in very little time using only Internet access to the advertising module from the user's computer 102. Next, FIGS. 13-18 show illustrative GUIs to effect the creation of an ad using the content creation module 120.

FIG. 13 shows a content manager GUI 1300 for use in ad creation or revision, according to an illustrative embodiment of the present invention. The content manager GUI 1300 includes a content manager toolbar 1310 for enabling the display of the content manager window. The GUI 1300 generally includes a list of media 1320, including images and backgrounds, an ad playlist (where ads are also identified as ‘messages’) 1310, and one or more action icons or buttons 1315.

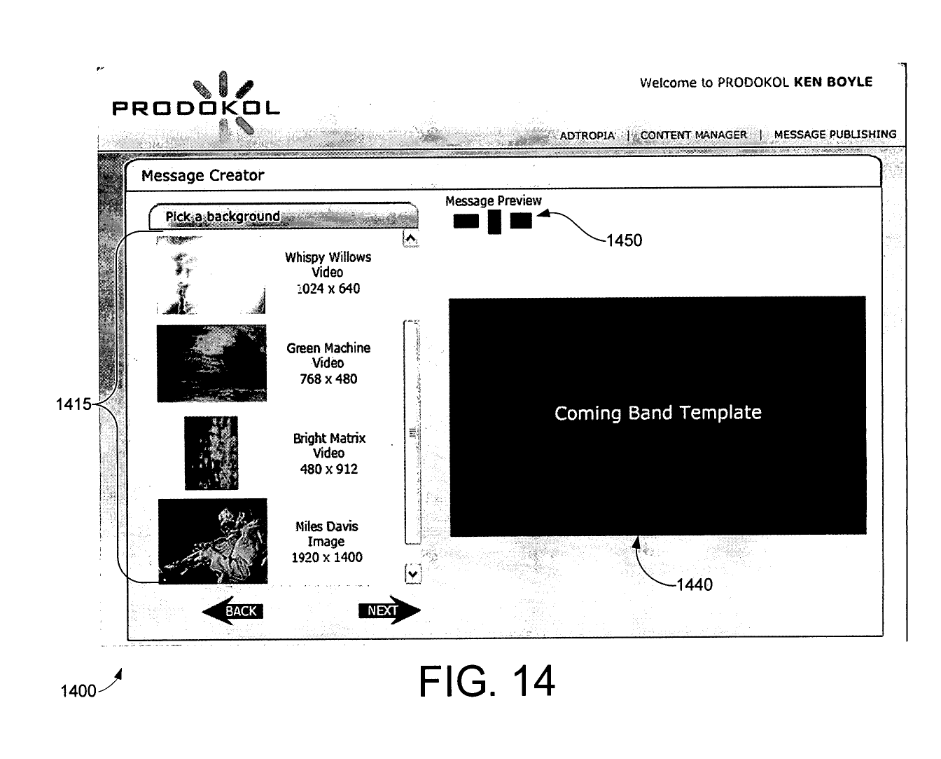

As described above with reference to FIG. 12, a user may select to generate a new ad by selecting media from the list of media 1320, or by selecting the “new” action icon or button. When this occurs, the user is presented with a message creator GUI, such as the 1400 of FIG. 14. The message creator GUI 1400 permits a user to select and/or upload media for use in ad creation or revision, according to an illustrative embodiment of the present invention. For instance, as shown in FIG. 14, a user may select one or more background images, animated gifs, or the like, from a list of backgrounds 1415. this may be accomplished, as any selection described herein, by clicking on a desired background. Prior to selection of a background, the ad template 1440 is illustrated to the user by the GUI 1400, along with a orientation tool 1450 that may permit a user to alter the orientation of a proposed ad. Because the user may generate an ad having a particular orientation, it will be appreciated that the ad may be reviewed by creative services 135 before publishing to ensure that it may be played on displays 165 associated with purchased ad space.

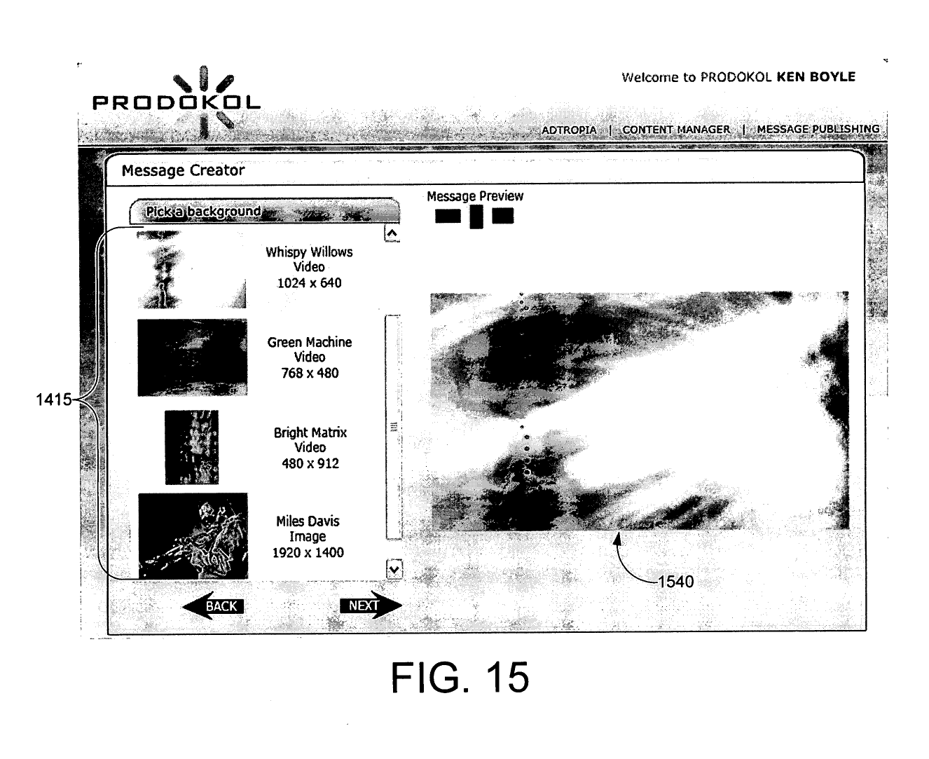

FIG. 15 shows the display of a user-selected background from the list backgrounds on the ad template 1540. Additionally, although not illustrated in the message creator GUI 1400 shown in FIGS. 14 or 15, the user may also upload media, such as a background, for generating an ad using the message creator GUI 1400. This may occur, for instance, via an upload button or icon (not illustrated) on the message creator GUI 1400. When selected the user is prompted with an upload screen, as known in the art, that permits the user to upload one or more media files stored on the user's computer 102 or at a remote site accessible to the user via the user computer 102. After the user uploads media files, they may be presented to the user in the list of backgrounds 1414.

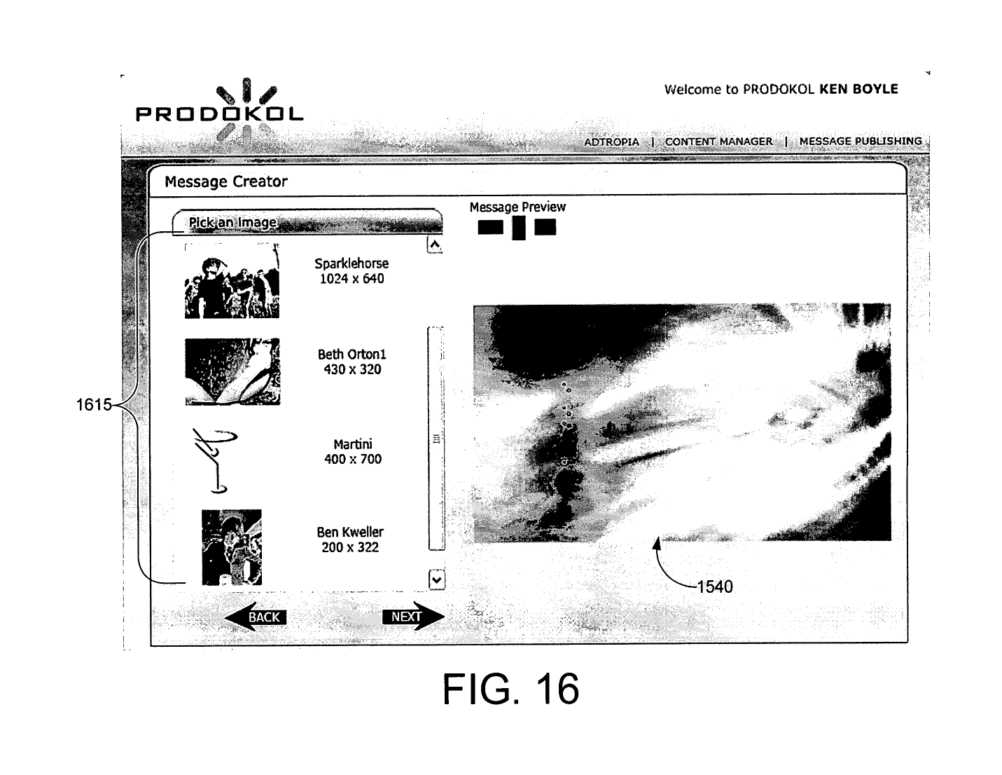

Next, FIG. 16 shows image media presented in a list of images 1615 on the message creator GUI 1400. According to an embodiment of the invention, the selection of images may occur immediately after a background is selected, and may be effected in the same manner as the selection of the backgrounds, as described above with reference to FIGS. 14 and 15. Therefore, one or more images may also be uploaded using a process similar to the uploading of one or more backgrounds. As shown in FIG. 16, the ad template 1540 is presented so that the image may be added in front of a background. After selection of an image, it may be sized and placed using drag and drop functions, as are known in the art.

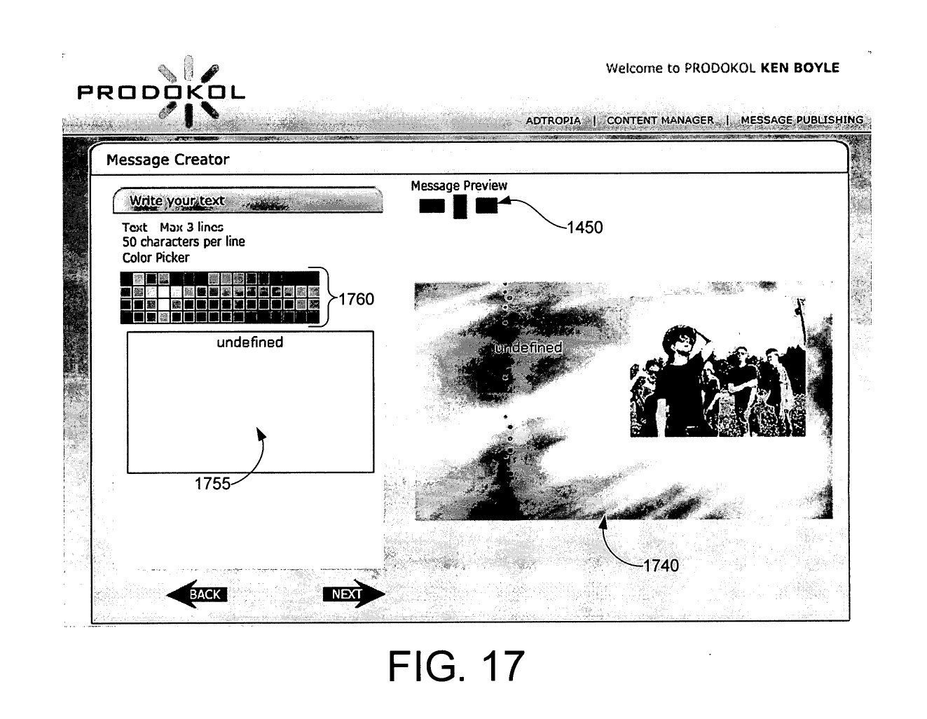

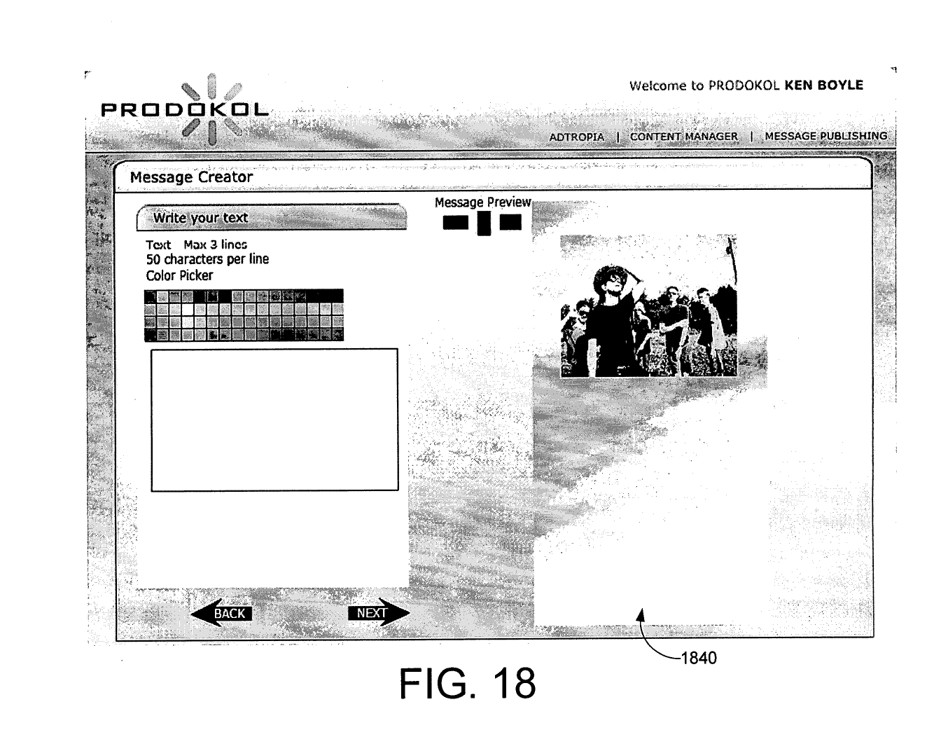

FIG. 17 shows a text insertion tool 1755 of the message creator GUI 1400 for use in ad creation or revision, according to an illustrative embodiment of the present. As shown, the text insertion tool may be used to add a text message to the ad 1740. The color of the text may be altered using a color tool 1760, and the text font may be selected using well known techniques, for instance by right clicking on highlighted text to alter its size, font, position, formatting, and the like. As illustrated in FIGS. 17 and 18, the orientation of an ad 1740, 1840 may be changed at any time by a user via the selection of orientation icons on the orientation tool 1450. As noted above, the orientation of the ad may be significant due to the orientation of one or more displays for playing the ad. Additionally, it will be appreciated that the orientation of the ad is significant for the insertion of text using the text insertion tool 1755.

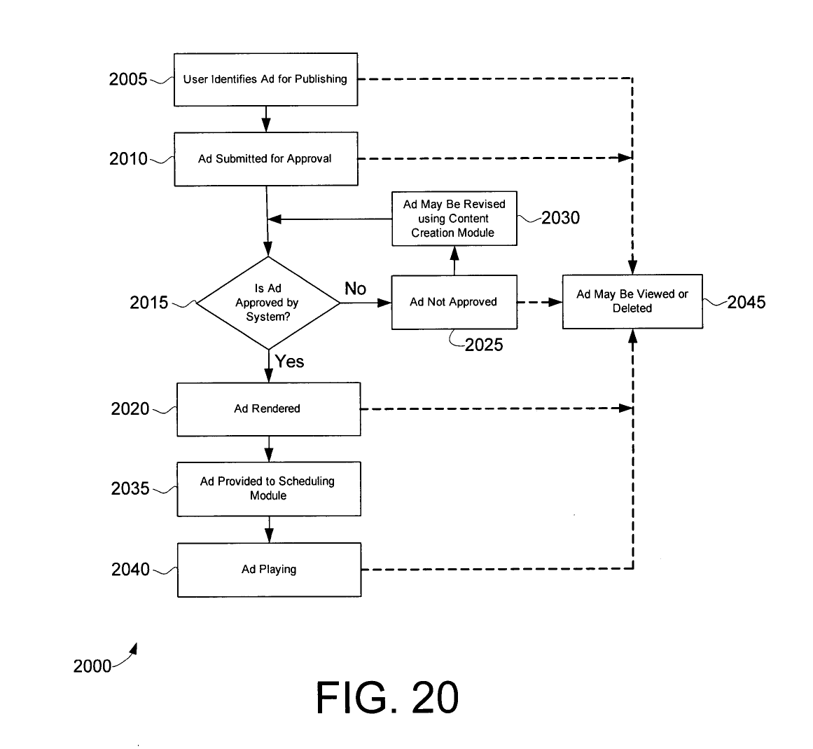

It should also be noted that although the message creator GUI 1400 is described above with reference to the creation of a new ad, the message creator GUI 1400 may be used to revise a previously stored ad. Additionally, it should be appreciated that any of the elements described above may be uploaded by a user, including an ad template. After an ad is created (which may include revision of an ad), the ad may be names and saved using a save tool 1970 on a save ad GUI 1900, according an illustrative embodiment of the present invention. Upon the saving of an ad it is added to provided in the ad playlist 1310. The ad playlist 1310 may also include a description associated with the status of the ad, as will be described below with reference to FIGS. 20-23.

FIGS. 13-18 describe only some embodiments of the present invention, and are not intended to be limiting. It will be appreciated that although the message creator GUI 1400 is described above as providing backgrounds and images for creating an ad, that an ad comprising video and/or audio may also be generated using more video production software that may be included in, or accessible from, the message creator GUI 1400. Therefore, the creation of ads by users may include ads having audio and video in addition to images, text, animated gifs, flash presentations, and the like. The creation of virtually any digital ad may be facilitated by the content creation module 120.

FIG. 20 is a block diagram flow chart of an ad approval process 2000, according to an illustrative embodiment of the present invention. According to one aspect of the invention, the ad approval process may be facilitated by the publishing module 125. Generally, after a user purchases ad space and creates or uploads an ad to be displayed on the purchased ad space, the ad must be approved by the system 100 (blocks 2005, 2010). The system is automatically alerted when new ads are added to the system 100 and are awaiting approval.

The approval process ensure that the ad contains appropriate content for publication and appropriate formatting, both in regard to the appearance of the ad and the actual format of the ad. For instance, when an ad is uploaded to the advertising module 114 it may be uploaded in a format that cannot be interpreted by the system 100. The approval process is carried out by the system 100 to identify whether changes need to be made to an ad before it is published. According to an aspect of the invention, the approval process may occur automatically without review of ad content, so that any ads having appropriate format are automatically published. According to an alternative aspect of the invention, creative services 135 must approve the contents and format of an ad prior to permitting it to publish.

If the ad is approved (block 2015), it may be rendered by the system (block 2020), which means that it is placed in a format that may be managed by the scheduling module 140 and displayed via a server 155, 170, 175 or network player 160a-160x. The rendered ad is then provided to the scheduling module (block 140) so that is may be played (block 2040) in ad space at one or more ad sties 130. On the other hand, an ad that is not approved may be revised by the user via the content creation module 120 (block 2030). According to another aspect of the invention, an ad may be altered by creative services where minor edits are required. If content services makes changes, the ad may be required to be approved by the user to ensure the user is pleased with the ad prior to its publication. As such, at any time an ad submitted for approval may be viewed or deleted by a user (block 2045).

FIG. 21 shows a message publisher GUI 2100 for use in ad approval and publishing, according to an illustrative embodiment of the present invention. The message publisher GUI 2100 includes a message publisher toolbar 2110 for accessing the message publisher GUI 2100. The message publisher GUI 2100 may also include a content manager toolbar 1310 to permit the user to access the content manager window, which was described in detail above. The GUI 1300 generally includes a list of ads for publication 2125, along with ad space information 2120, user-input information 2130, and status 2135 for each ad listed for publication 2125. The GUI 2100 may also include view and delete icons or buttons by which a user may view or delete an ad listed for publication 2125.

As shown in FIG. 21, after a user has purchased ad space for which an ad has not been selected, the GUI 2100 will permit the insertion of an ad into an empty position 2115 in the publication list 2125, where the empty position is located next to ad space information that corresponds to the ad space purchased by the user. For instance, FIG. 21 shows ad space information identifying that an ad is to be played June 1^{st}-31^{st}, and is a 15 second ad that runs once every hour. According to one aspect of the invention, the playing of an ad on a user-selected ad space may be based on duration of an advertisement, which is displayed to the user via the ad space information 2120. For example, the duration of an ad may impact the number of times it runs over the course of a fixed period of time, such as every hour. This information may be automatically determined by the scheduling module, and may be dependent on the advertising site 130.

As described above, ad space is typically purchased by a user at an ad site for a large block of time, such as a month. Within that time period, the scheduling module 140 is operable to determine not only how often to play the ad, but also when to play the ad within the purchased ad space. Thus, an ad lasting 15 seconds may be played twice as often as an ad lasting 30 seconds so that users paying an equivalent amount for ad space over a particular time period each receive the same total amount of play time, even though they may have an unequal amount of play time over any small timeframe within the purchased period. The ad space information 2120 may therefore be automatically identified by the scheduling module 140.

Using the GUI 2100, the user may insert an ad into the empty location 2115 in the publication list 2125. This may occur, for instance, by dragging an ad from the ad playlist 1310 within the content manager window. According to another aspect of the invention, clicking on the empty location 2115 will automatically present the user with the ad playlist 1310, and the subsequent selection of an ad from the ad playlist 1310 will insert the ad into the empty location 2115.

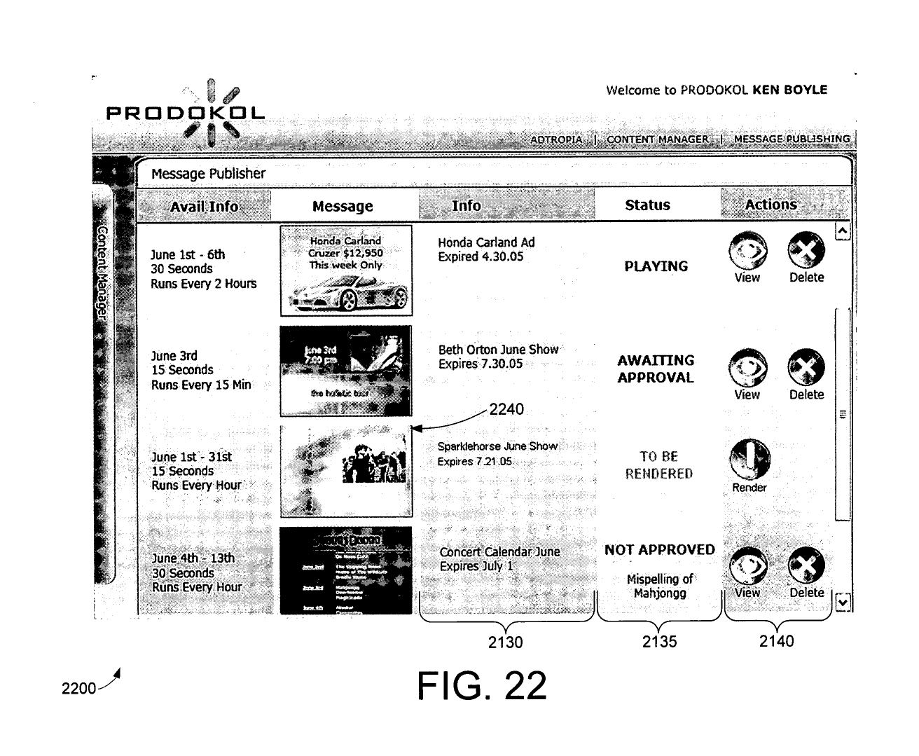

FIG. 22 shows the message publisher GUI of FIG. 21 after a user has inserted an ad 2240 into the empty location 2115 in the publication list 2125. Upon inserting the ad 2240, the user may add user-input information 2130 as notes associated with the add. Additionally, upon adding the ad to the publication list 2125, the status 2135 of the ad immediately changes to “awaiting approval”. A message is then transmitted to the digital signage publisher network 105 to approve of the ad. If the ad is not approved, a “not approved” status may be displayed, along with information identifying problems with the ad. Therefore, the user may use the content creation module 120 to revise the ad, and the publishing module to re-submit the revised ad.

On the other hand, where an ad is approved, a “to be rendered” message will appear while the digital signage network is processing the ad so that it may be displayed on the purchase ad space. According to another aspect of the invention, the user may be required to select a render icon or button as the final step in submitting an ad for display. Rendering may include, for instance, downloading the ad from the advertising module 114 and placing in a format that may be managed by the scheduling module 140 and displayed via a server 155, 170, 175 or network player 160a-160x. Finally, after an ad begins playing on one or more ad sites 130, the status may read “playing”. As is also shown in FIG. 22, the GUI 2200 may also include view or delete icons or buttons 2140 to permit a user to view or delete an ad within the publication list 2125.

Using the present invention the publication of user-created ads on selected digital media (i.e., displays 165 at ad sites 130) may be accomplished quickly using the process described above. However, it should also be appreciated that the ad space selection module 115 of the present invention may operate without the selection of an advertising site using digital signage. For instance, a user may utilize the features of the ad space selection module to identify and purchase conventional ad space, such as print ads in newspapers. Additionally, the content creation module may be used to create such print ads, and the publication module may forward the print ad to the publisher of the conventional ad space.

FIG. 23 shows a home screen GUI 2300 for use in managing ads, according to an illustrative embodiment of the present invention. The GUI 2300 may be the welcome screen to users that have logged in, for instance, using the log-in and search graphical user interface (GUI) 400 of FIG. 4. The GUI 2300 includes links 410, 415, 420, respectively, to the ad space search and selection GUI 600 of FIG. 6, the content manager GUI 1300 of FIG. 13, and a message publisher GUI 2100 of FIG. 21. The GUI 2300 may also provide a the user with a summary of the user's active ads (i.e., active media), and expired ads (i.e., expired media), along with an indication as the number of ad sites the ads are (or were) active in. News items may also be provided to the user via the home screen GUI 2300.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for placing media content, comprising:
receiving, at a server, a user request to identify available media space, where the user request includes one or more user-identified search criteria, and wherein the available media space represents media space available for purchase by the user;
determining, at the server, the available media space that meets the one or more user-identified search criteria; and
displaying the available media space to the user for purchase.

2. The method of claim 1, further comprising receiving a request, from the user, to purchase at least some of the available media space.

3. The method of claim 2, further comprising selling the at least some of the available media space to the user.

4. The method of claim 3, further comprising providing the user at least one media space selection module operable to:
permit the user to input the one or more user-identified search criteria;
review the available media space meeting the one or more user-identified search criteria, and
purchase the at least some of the available media space,
wherein the at least one media space selection module is accessible by the user via the Internet.

5. The method of claim 3, further comprising receiving a request, from the user, to publish media content on the media space sold to the user.

6. The method of claim 5, further comprising providing at least one media creation module accessible by the user and operable to permit the user to create, at least in part, the media content for publishing on the media space sold to the user.

7. The method of claim 5, further comprising publishing the media content on the media space sold to the user.

8. The method of claim 7, further comprising scheduling the publishing of the media content on the media space sold to the user.

9. The method of claim 7, wherein publishing the media content comprises displaying the media content on at least one display.

10. The method of claim 7, wherein publishing the media content comprises publishing the media content in printed material.

11. The method of claim 7, wherein the media content comprises an advertisement.

12. The method of claim 7, wherein the media content comprises real-time or near-real time content.

13. The method of claim 5, further comprising providing a publishing module operable to permit the user to input the request to publish the media content on the media space sold to the user.

14. The method of claim 13, further comprising reviewing the media content requested for publication by the user.

15. The method of claim 14, further comprising approving of the user request to publish the media content, prior to publishing the media content on the media space sold to the user.

16. The method of claim 14, further comprising instructing the user that the media content must be revised before the media content is published.

17. A method for the sale of advertising space at one or more advertising sites, comprising:
receiving, at a server, a user request to identify available advertising sites, wherein the user request includes one or more user-identified search criteria;
determining, at the server, the available advertising sites that meet the one or more user-identified search criteria; and
offering for sale, to the user, advertising space in at least some of the available advertising sites.

18. The method of claim 17, further comprising providing at least one content creation tool for access by the user, wherein the at least one content creation tool is operative to allow the user to create and store advertisements.

19. The method of claim 17, further comprising:
receiving a request, from the user, for the purchase of advertising space in at least some of the available advertising sites; and
selling the at least some of the available advertising space to the user.

20. The method of claim 19, further comprising providing a publishing module operable to permit a user to publish an advertisement on the advertising space sold to the user.

21. The method of claim 20, further comprising:
receiving a request, from the user, to publish an advertisement on the advertising space sold to the user; and
publishing the advertisement on the advertising space sold to the user.

22. The method of claim 21, further comprising scheduling the publishing of the advertisement on the advertising space sold to the user.

23. The method of claim 21, wherein the in at least some of the available advertising sites comprises a video network.

24. The method of claim 21, wherein the advertisement comprises real-time or near-real time content.

25. The method of claim 19, further comprising generating a bill corresponding to the sale of advertising space sold to the user.

26. The method of claim 21, further comprising approving of the user request to publish the advertisement, prior publishing the advertisement on the advertising space sold to the user.

27. A media distribution system, comprising:
a server, operable to communicate with a computer corresponding to a user; and
a media space selection module, in communication with the server, wherein the media space selection module is operable to:
receive one or more user-identified search criteria to identify available media space, wherein the available media space represents media space available for purchase by the user;
determine the available media space that meets the one or more user-identified search criteria; and
display, on at least one display corresponding to the computer, the available media space to the user for purchase.

28. The system of claim 27, wherein the media space selection module is further operable to receive a request, from the user, to purchase at least some of the available media space.

29. The system of claim 28, further comprising at least one credit card authorization server, in communication with the server, wherein the at least one credit card authorization server is operable to process payment relating to the sale of at least some of the available media space to the user.

30. The system of claim 27, wherein the at least one media space selection module is accessible by the user via the Internet.

31. The system of claim 27, further comprising a media creation module accessible by the user and operable to permit the user to create, at least in part, the media content for publishing on the media space sold to the user.

32. The system of claim 27, further comprising a publishing module operable to permit the user to input the request to publish the media content on the media space sold to the user.
